(19) United States
(12) Patent Application Publication
(10) Pub. No.: US 2026/0005375 A1
(43) Pub. Date: Jan. 1, 2026

(54) ENERGY STORAGE APPARATUS

(71) Applicant: GS Yuasa International Ltd., Kyoto-shi (JP)

(72) Inventors: Yosuke NISHIMURA, Kyoto-shi (JP); Kosuke HAYASHI, Kyoto-shi (JP)

(21) Appl. No.: 19/320,689

(22) Filed: Sep. 5, 2025

Related U.S. Application Data
(63) Continuation of application No. PCT/JP2024/008915, filed on Mar. 8, 2024.

(30) Foreign Application Priority Data
Mar. 8, 2023 (JP) 2023-035318

(51) Int. Cl. H01M 50/264; H01M 50/209; H01M 50/24; H01M 50/271; H01M 50/588; H01M 50/593

(52) U.S. Cl. CPC H01M 50/264; H01M 50/209; H01M 50/24; H01M 50/271; H01M 50/588; H01M 50/593

(57) ABSTRACT

An energy storage apparatus includes a stack including energy storage devices arranged in a first direction, a holder holding the stack and including an extension extending from a first end of the stack to a second end of the first direction of the stack along an end of the stack in a second direction perpendicular to the first direction, and an insulator that insulates between the stack and the extension and includes an insulator body that extending along an opposing surface of the stack in the extension, and a rib extending from the insulator body in the second direction to contact with the stack, the rib extending between two of the energy storage devices and including a baffle that is convex on one side in a third direction perpendicular to the first and second directions, and the baffle is between the energy storage devices adjacent in the first direction.

### CROSS REFERENCE TO RELATED APPLICATIONS

This application claims the benefit of priority to Japanese Patent Application No. 2023-035318 filed on Mar. 8, 2023 and is a Continuation Application of PCT Application No. PCT/JP2024/008915 filed on Mar. 8, 2024. The entire contents of each application are hereby incorporated herein by reference.

### BACKGROUND OF THE INVENTION

### 1. Field of the Invention

The present invention relates to energy storage apparatuses each including a plurality of energy storage devices.

### 2. Description of the Related Art

Conventionally, a battery module in which a plurality of batteries is restrained by a restraint member has been known (see WO 2020/090216). As shown in FIG. 23, the battery module 100 includes a plurality of batteries 101, a plurality of separators 102, one pair of end plates 103, and one pair of restraint members 104.

Each of the plurality of batteries 101 includes a flat rectangular parallelepiped-shaped exterior case 101a. A substantially rectangular opening is provided on one surface of the exterior case 101a, and a sealing plate 101b that seals the exterior case 101a is provided in the opening. The plurality of batteries 101 is stacked at predetermined intervals such that main surfaces of the adjacent batteries 101 face each other.

The separator 102, which is also called an insulating spacer, is disposed between two adjacent batteries 101 to electrically insulate the exterior cases 101a of the two adjacent batteries 101.

The stacked plurality of batteries 101 and the plurality of separators 102 are interposed between the one pair of end plates 103. The one pair of end plates 103 is disposed to be adjacent to the batteries 101 at both ends in the stacking direction of the batteries 101 via the separators 102.

Each of the one pair of restraint members 104 is an elongated member having the stacking direction as the longitudinal direction. The one pair of restraint members 104 is disposed to face each other in a direction parallel to the longitudinal direction of the sealing plate 101b. The plurality of batteries 101, the plurality of separators 102, and the one pair of end plates 103 are interposed between the one pair of restraint members 104. Each restraint member 104 includes a rectangular flat portion 104a extending parallel to side surfaces of the batteries 101 and four flange parts 104b protruding from respective end edges of the flat portion 104a.

The flat portion 104a is provided with an opening 104c that exposes side surfaces of the batteries 101. The opening 104c exposes the side surfaces of the plurality of batteries 101 arranged consecutively in the stacking direction.

In the above-described battery module 100, during use, condensation water W1 generated on the side surface of the exterior case 101a of each battery 101 may flow down along the side surface and accumulate at the contact position x between the plurality of batteries 101 and an opening peripheral portion of the flat portion 104a of the restraint member 104 (opening peripheral portion of the opening 104c) (see the sign W1 in the enlarged view of FIG. 23).

Since the contact position α extends along the opening peripheral portion, if the condensation water W1 accumulates at the contact position α, the condensation water W1 extends (extends) in the stacking direction along the opening peripheral portion. As a result, the adjacent batteries 101 (exterior cases 101a) become conductive due to the condensation water, leading to the occurrence of electrolytic corrosion in the conductive batteries 101 (exterior cases 101a).

### SUMMARY OF THE INVENTION

Example embodiments of the present invention provide energy storage apparatuses that each reduce or prevent conduction between adjacent energy storage devices.

An energy storage apparatus according to an example embodiment of the present invention includes a stacked product including a plurality of energy storage devices arranged in a first direction, a holder to hold the stacked product and including an extension extending in the first direction from a first end of the stacked product to a second end of the stacked product along an end of the stacked product in a second direction perpendicular to the first direction, and an insulator to insulate between the stacked product and the extension, wherein the insulator includes an insulator body extending along an opposing surface of the stacked product in the extension, and a rib extending from the insulator body in the second direction and to come into contact with the stacked product, the rib extending from the energy storage device at a first end to the energy storage device at a second end in the first direction among the plurality of energy storage devices, the rib includes a baffle that is convex on one side in a third direction perpendicular to the first direction and the second direction, and a portion of the baffle is between adjacent ones of the plurality of energy storage devices in the first direction.

As described above, according to the present example embodiment, an energy storage apparatus that can reduce or prevent conduction between adjacent energy storage devices can be provided.

The above other and elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of an energy storage apparatus according to the present example embodiment of the present invention.

FIG. 2 is a view of the energy storage apparatus as seen from the Y-axis direction.

FIG. 3 is an exploded perspective view of the energy storage apparatus.

FIG. 4 is a view of a stacked product included in the energy storage apparatus as seen from the Y-axis direction.

FIG. 5 is a perspective view of a first adjacent structure included in the energy storage apparatus.

FIG. 6 is a view of the first adjacent structure as seen from the X-axis direction.

FIG. 7 is a view of the first adjacent structure as seen from the Y-axis direction.

FIG. 8 is a cross-sectional view at the VIII-VIII position of FIG. 6.

FIG. 9 is a cross-sectional view at the IX-IX position of FIG. 7.

FIG. 10 is a cross-sectional view at the X-X position of FIG. 7.

FIG. 11 is a view of an energy storage device included in the energy storage apparatus and two first adjacent structures sandwiching the energy storage device as seen from the Y-axis direction.

FIG. 12 is a perspective view of a second adjacent structure included in the energy storage apparatus.

FIG. 13 is a view of an extension included in the energy storage apparatus as seen from the Y-axis direction.

FIG. 14 is a perspective view of an insulator included in the energy storage apparatus.

FIG. 15 is a perspective view of the insulator.

FIG. 16 is a view of the insulator as seen from the inside in the Y-axis direction.

FIG. 17 is a view of the insulator as seen from the outside in the Y-axis direction.

FIG. 18 is an enlarged cross-sectional view at the XVIII-XVIII position of FIG. 16.

FIG. 19 is an enlarged view of a portion of the cross-section at the XIX-XIX position of FIG. 2.

FIG. 20 is an enlarged view of a portion of the cross-section at the XX-XX position of FIG. 2.

FIG. 21 is a partially enlarged perspective view of the state cut at the XXI-XXI position of FIG. 19.

FIG. 22 is an enlarged perspective view of the region corresponding to FIG. 21 in the energy storage apparatus (region outside in the Y-axis direction).

FIG. 23 is a perspective view of a conventional battery module.

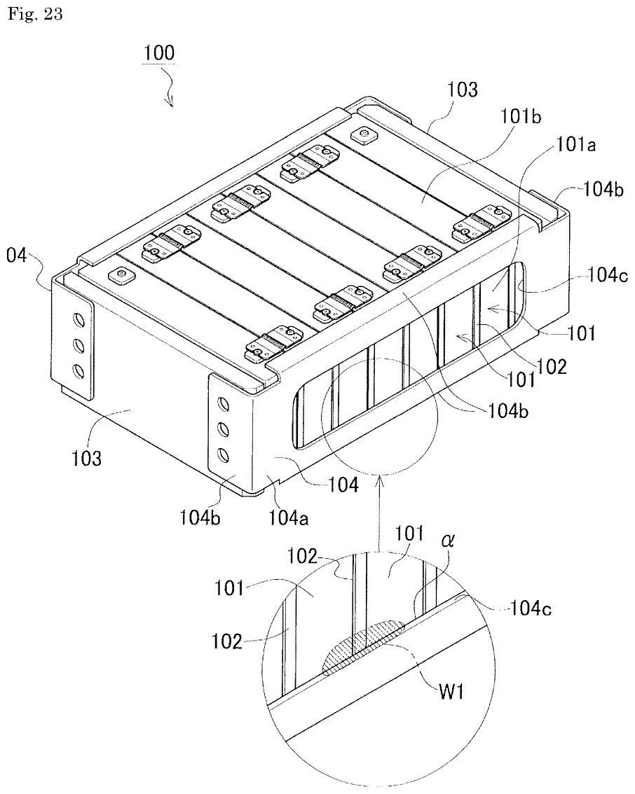

### DETAILED DESCRIPTION OF THE EXAMPLE EMBODIMENTS

(1) An energy storage apparatus according to an example embodiment of the present invention includes a stacked product including a plurality of energy storage devices arranged in a first direction, a holder to hold the stacked product and including an extension extending in the first direction from a first end of the stacked product to a second end of the stacked product along an end of the stacked product in a second direction perpendicular to the first direction and an insulator to insulate between the stacked product and the extension, wherein the insulator includes an insulator body extending along an opposing surface of the stacked product in the extension, and a rib extending from the insulator body in the second direction and to come into contact with the stacked product, the rib extending from the energy storage device at a first end to the energy storage device at a second end in the first direction among the plurality of energy storage devices, the rib includes a baffle that is convex on one side in a third direction perpendicular to the first direction and the second direction, and a portion of the baffle is between adjacent ones of the plurality of energy storage devices in the first direction.

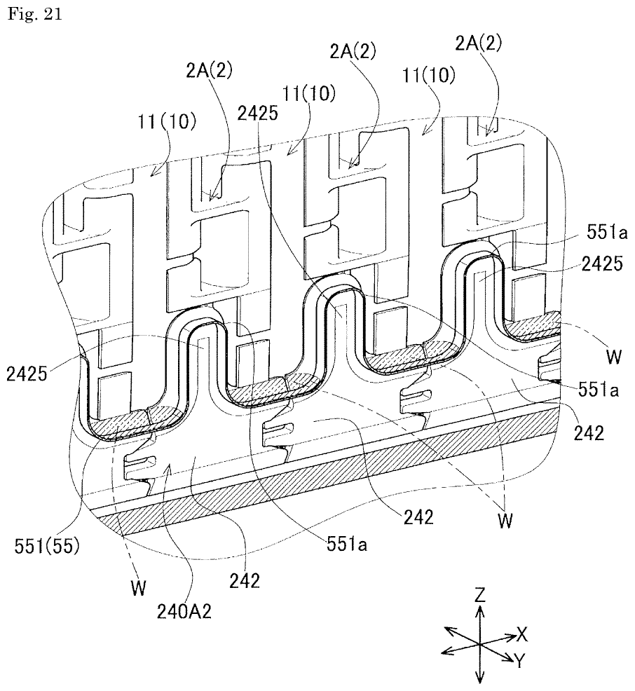

When the energy storage apparatus is positioned with one end in the third direction facing upward, if water such as condensation is present on the surface of the stacked product, the water may flow down along the surface of the end of the stacked product in the second direction, and the water may accumulate at the contact position between the stacked product and the rib (see FIG. 21). In this case, with the energy storage apparatus according to an example embodiment of the present invention, in the range where the rib extends in the first direction, the baffle can reduce or prevent conduction between adjacent energy storage devices due to the water. Therefore, the occurrence of electrolytic corrosion caused by the water is reduced or prevented in the adjacent energy storage devices.

(2) In the energy storage apparatus according to (1) described above, the stacked product may include three or more of the energy storage devices arranged consecutively, the stacked product may include an adjacent structure between the adjacent energy storage devices and including an insulation property, the adjacent structure may include a partial portion that covers a portion of an end surface of the energy storage device adjacent to the adjacent structure in the second direction, a plurality of the partial portions of the adjacent structures may be connected in the first direction to define a cover, and the rib may be in contact with the cover.

With the energy storage apparatus according to (2) described above, when the energy storage apparatus is positioned with one end of the third direction facing upward and the water such as condensation is present at the contact position between the rib and the cover, both the cover and the rib have insulating properties. Therefore, in the range where the rib extends in the first direction, the conduction caused by the water between the energy storage devices included in the stacked product is more effectively reduced or prevented. This makes it less likely that water-induced electrolytic corrosion will occur.

(3) In the energy storage apparatus according to (2) described above, the cover may include an inclined surface that extends along an edge on one side of the third direction and approaches the energy storage device in the second direction toward the edge, and the rib may bend such that a distal end of the rib follows the inclined surface.

With the energy storage apparatus according to (3) described above, the rib bends such that the distal end follows the inclined surface of the cover, causing the distal end of the rib to be pressed against the cover, thus providing close contact between the rib and the cover. This more reliably prevents the water from entering between the rib and the cover.

(4) In the energy storage apparatus according to (2) described above, the baffle may be located at a position corresponding to (facing) a space between the adjacent energy storage devices in the rib, and at an edge on one side of the cover in the third direction, in a range where the rib is arranged in the first direction, a convex portion having a shape that is convex on one side in the third direction and corresponds to (faces) the baffle may be located at a position corresponding to (similar to) the baffle.

With the energy storage apparatus according to (4) described above, when the energy storage apparatus is positioned with one end of the third direction facing upward, the conduction due to the water, such as condensation, between the adjacent energy storage devices is prevented at the contact position between the stacked product and the rib.

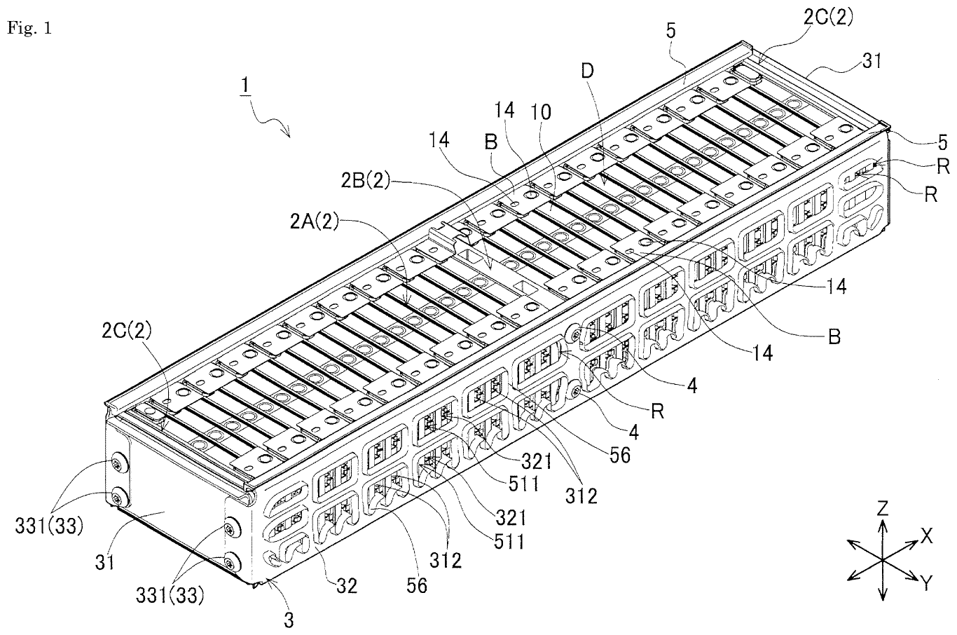

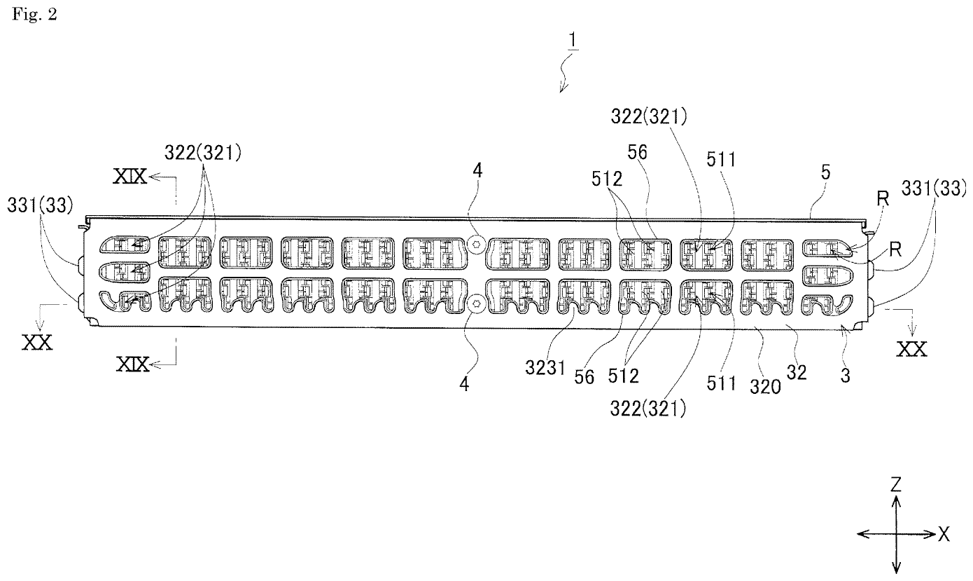

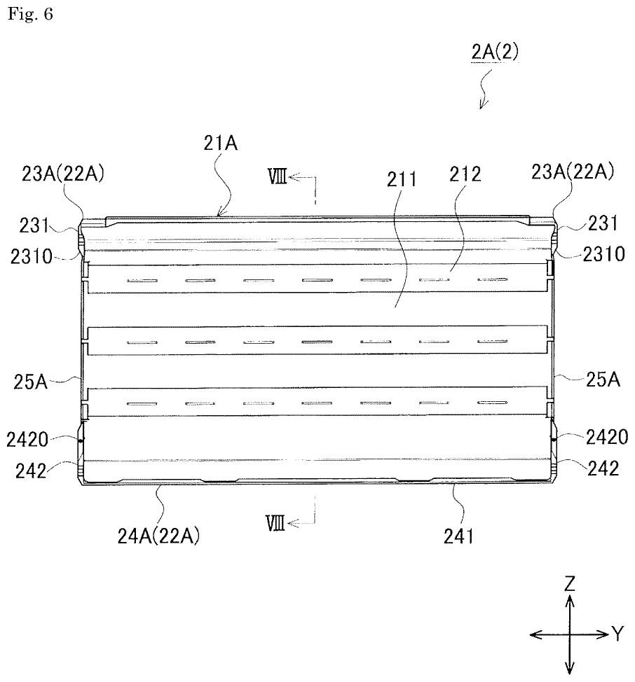

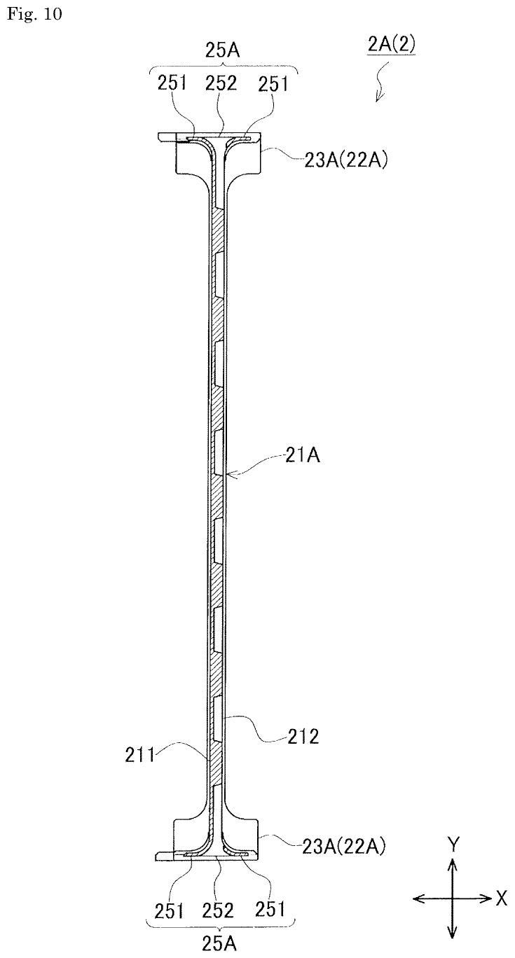

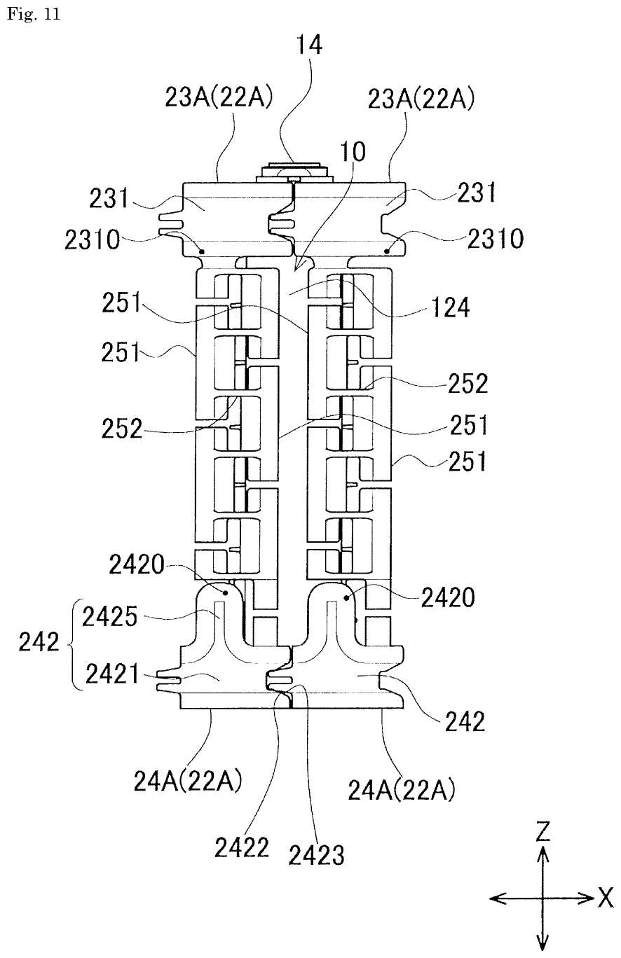

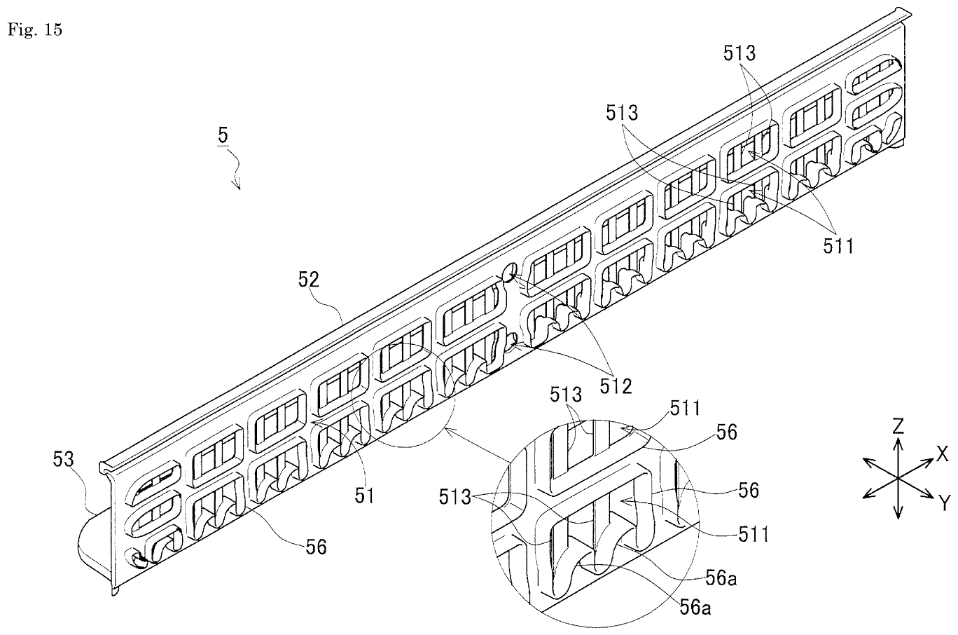

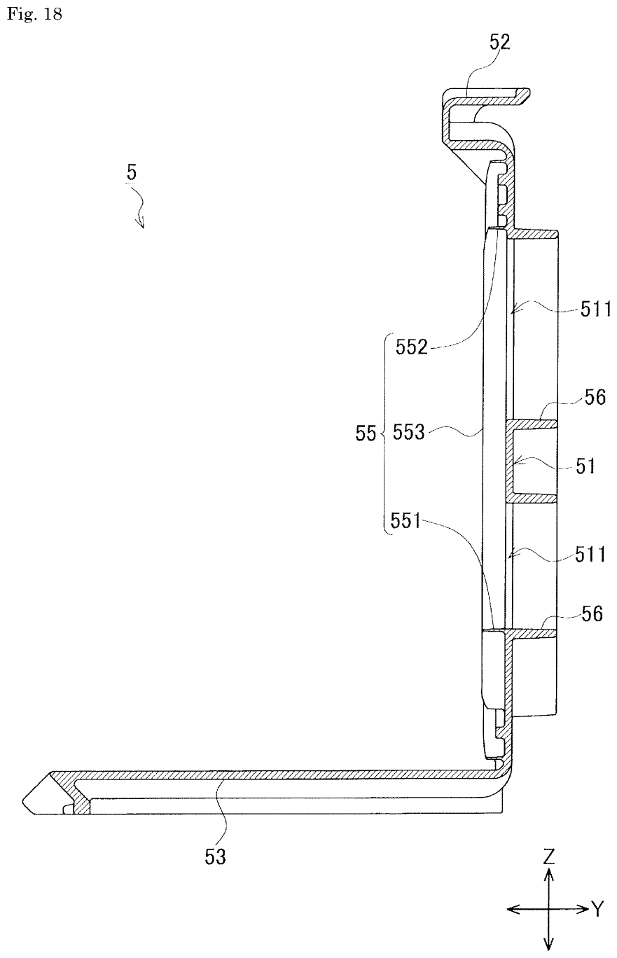

A description of example embodiments of the present invention will be given below with reference to FIGS. 1 to 22. The name of a structural element or feature of example embodiments of the present invention is specific to the example embodiments of the present invention and may differ from the name of a structural element or feature in the background art.

An energy storage apparatus 1 of the present example embodiment includes, as shown in FIGS. 1 to 4, a stacked product D including a plurality of energy storage devices 10 arranged in a first direction, a holder 3 that holds the stacked product D, and an insulator 5 that insulates between the stacked product D and an extension 32, which is a portion of the holder 3. The energy storage apparatus 1 includes a first fixing portion 4 that fixes adjacent structures 2 to the stacked product D, and a plurality of bus bars B that conductively connects different energy storage devices 10 to each other or connects an external device or the like to the energy storage device 10. Details will be described as follows.

The stacked product D includes three or more energy storage devices 10 and the plurality of adjacent structures 2, each of which is arranged between the adjacent energy storage devices 10 and has insulating properties. In the stacked product D, the energy storage devices 10 and the adjacent structures 2 are arranged alternately in the first direction.

Each of the energy storage devices 10 includes a primary battery, a secondary battery, a capacitor, or the like. The energy storage device 10 of the present example embodiment is a charge-discharge enabled nonaqueous electrolyte secondary battery. More specifically, the energy storage device 10 is a lithium ion secondary battery that utilizes the movement of electrons caused by the movement of lithium ions.

The energy storage device 10 includes an electrode assembly, a case 11 that houses the electrode assembly along with an electrolyte solution, terminals 14 that are partially exposed outside the case 11, and a current collector that connects the electrode assembly to the terminals 14. The case 11 of the present example embodiment is made of metal such as stainless steel, aluminum, or aluminum alloy, and there is no insulating sheet or the like disposed on the surface of the case 11. The energy storage device 10 of the present example embodiment is in a state where metal of the case 11 is exposed to the outside.

In the electrode assembly, positive electrode plates and negative electrode plates are alternately stacked via separators. In the electrode assembly, lithium ions move between the positive electrode plate and the negative electrode plate, thus allowing the energy storage device 10 to charge and discharge.

The case 11 includes a case body 12 having an opening and a plate-shaped lid plate 13 that covers (closes) the opening of the case body 12. The case body 12 has a rectangular tube shape with one end closed in the opening direction (that is, bottomed rectangular tube shape), and the case 11 has a rectangular parallelepiped shape (six-sided shape).

The case body 12 includes a plate-shaped closing portion 121 and a cylindrical body portion (peripheral wall) 122 extending from the periphery of the closing portion 121.

The closing portion 121 is a region located at the lower end of the case body 12 when the case body 12 is positioned with the opening facing upward (that is, serving as a bottom wall of the case body 12 when the opening faces upward). The closing portion 121 is rectangular when viewed from the normal direction of the closing portion 121.

The body portion 122 has a rectangular tube shape, in more detail, a flattened rectangular tube shape. The body portion 122 includes one pair of long wall portions 123 extending from the long sides at the periphery of the closing portion 121, and one pair of short wall portions 124 extending from the short sides at the periphery of the closing portion 121. In the body portion 122, the short wall portion 124 connects ends of the pair of long wall portions 123, thus providing the body portion 122 having a rectangular tube shape.

The lid plate 13 is a plate-shaped structure that covers the opening of the case body 12. The lid plate 13 of the present example embodiment is rectangular plate-shaped. The lid plate 13 is joined to the case body 12 in a state where the peripheral portion of the lid plate 13 is overlapped with the peripheral portion of the opening of the case body 12 to provide the case 11.

The above-described case 11 has a flat rectangular parallelepiped shape. The plurality of energy storage devices 10 is arranged in the first direction with wide surfaces of the case 11 (long wall portions 123) facing each other via the adjacent structures 2.

Each of the terminals 14 is a region that is electrically connected to the terminal 14 of another energy storage device 10, to an external device, or the like. The terminal 14 has conductivity. The terminal 14 may include an aluminum-based metallic material such as aluminum or aluminum alloy, a copper-based metallic material such as copper or copper alloy, or the like. The energy storage device 10 of the present example embodiment includes one pair of terminals 14, and the two terminals 14 are disposed at both ends of the lid plate 13 in the longitudinal direction.

In the following description, the direction in which the plurality of energy storage devices 10 is arranged is defined as the X-axis direction (first direction) of the perpendicular coordinate system. The direction in which the short wall portions 124 of the case 11 face each other, that is, the alignment direction of the one pair of terminals 14 in the energy storage device 10 is defined as the Y-axis direction (second direction) of the perpendicular coordinate system. The direction in which the lid plate 13 and the closing portion 121 face each other is defined as the Z-axis direction (third direction) of the perpendicular coordinate system.

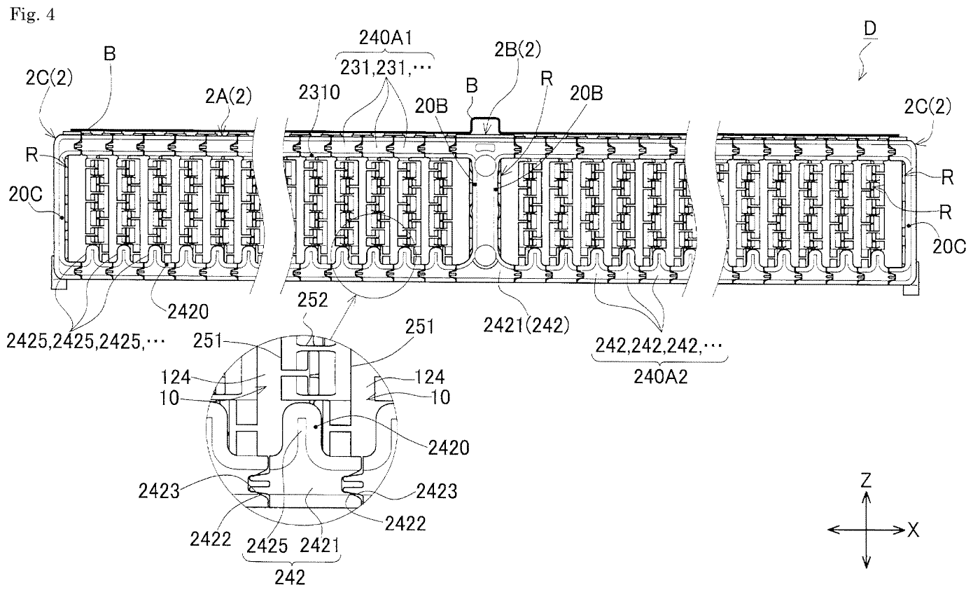

The adjacent structure 2 includes partial portions 231 and 242 that cover a portion of end surfaces in the Y-axis direction of the energy storage device 10 adjacent to the adjacent structure 2 (outer surface of the short wall portion 124). The partial portions 231 and 242 of the plurality of adjacent structures 2 are connected in the X-axis direction to construct covers 240A1 and 240A2 (see FIG. 4). The adjacent structure 2 has insulating properties and is disposed between the energy storage devices 10 arranged in the X-axis direction (adjacent to each other), or between the energy storage device 10 and a structure arranged in the X-axis direction with respect to the energy storage device 10 (terminal portion 31, which is part of the holder 3 in the present example embodiment). The adjacent structure 2 of the present example embodiment may include resin. The adjacent structure 2 defines a flow path R through which a fluid for temperature adjustment (gas such as air in the present example embodiment) can flow between the adjacent energy storage devices 10. The plurality of adjacent structures 2 includes a plurality of types of adjacent structures 2A, 2B, and 2C.

The plurality of adjacent structures 2 includes a first adjacent structure 2A, a second adjacent structure 2B, and a third adjacent structure 2C. The first adjacent structure 2A is arranged between the two adjacent energy storage devices 10. The second adjacent structure 2B is arranged between the two adjacent energy storage devices 10 and is fixed to the holder 3. The third adjacent structure 2C is arranged between the holder 3 and the energy storage device 10 located at the far end in the X-axis direction, and adjacent to the energy storage device 10. The energy storage apparatus 1 includes, as the adjacent structures 2, the first adjacent structure 2A, the second adjacent structure 2B, and the third adjacent structure 2C. The energy storage apparatus 1 of the present example embodiment includes a plurality of the first adjacent structures 2A, one of the second adjacent structure 2B, and two of (one pair of) the third adjacent structures 2C. The plurality of first adjacent structures 2A is arranged between the plurality of energy storage devices 10, excluding between two energy storage devices 10 where the second adjacent structure 2B is arranged.

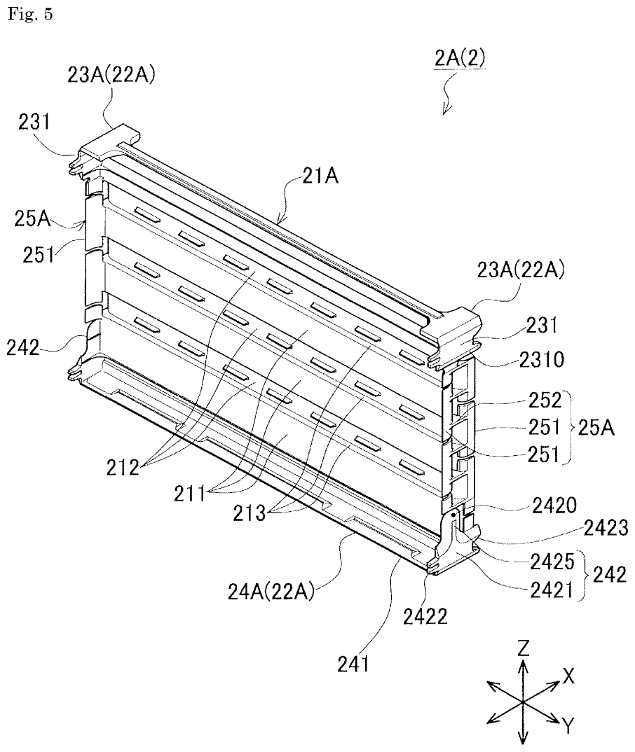

As shown in FIGS. 5 to 8, each of the first adjacent structures 2A includes a first body portion 21A located between the energy storage devices 10, and a first regulation portion 22A (regulation portion) that regulates relative movement of the energy storage device 10 adjacent to the first body portion 21A with respect to the first body portion 21A. The first adjacent structure 2A includes upper partial portions 231 that cover a portion of the end surface in the Y-axis direction of the energy storage device 10 adjacent to the first body portion 21A (short wall portion 124 of the case 11) (end of one side in the Z-axis direction at the end surface in the Y-axis direction in the present example embodiment). The first adjacent structure 2A includes lower second partial portions 242 (partial portions) that cover a portion of the end surface in the Y-axis direction of the energy storage device 10 adjacent to the first body portion 21A (end of the other side in the Z-axis direction at the end surface in the Y-axis direction in the present example embodiment). The first adjacent structure 2A of the present example embodiment also includes central covers 25A that cover the central part in the Z-axis direction of the end surface in the Y-axis direction of the energy storage device 10 adjacent to the first body portion 21A. In the first adjacent structure 2A of the present example embodiment, a portion of the first regulation portion 22A constructs the upper partial portion 231 or the lower second partial portion 242.

The first body portion 21A is a region extending in the direction of the Y-Z plane (plane including the Y-axis direction and the Z-axis direction) and facing the long wall portion 123 of the case 11 of the energy storage device 10 in a state of contact. The first body portion 21A cooperates with the adjacent energy storage device 10 to define the flow path R between the first body portion 21A and the energy storage device 10, through which a fluid for temperature adjustment can flow. The first body portion 21A is a rectangular plate-shaped component that has a size facing the entire surface of the long wall portion 123 of the case 11 of the energy storage device 10 (size facing the entire surface of the long wall portion 123 of the case 11) when viewed from the X-axis direction, and its cross-sectional shape along the X-Z plane (plane including the X-axis direction and the Z-axis direction) is a rectangular waveform.

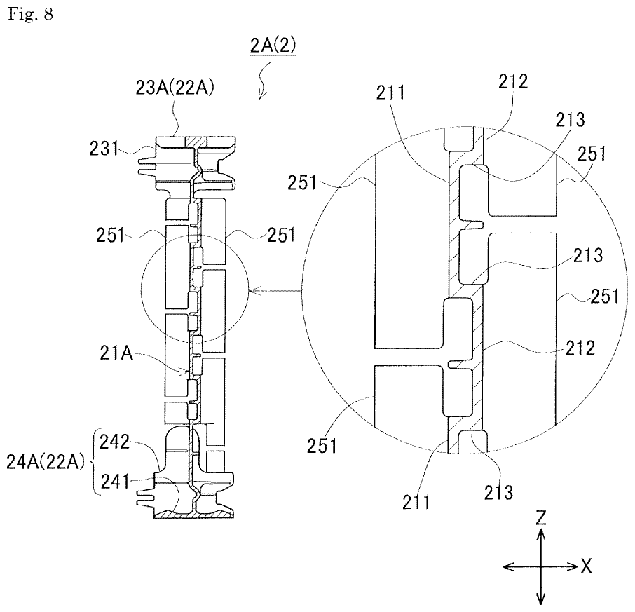

The first body portion 21A includes a plurality of first contact portions 211 that comes into contact with one energy storage device 10 out of the two adjacent energy storage devices 10 with the first body portion 21A interposed therebetween in the X-axis direction, a plurality of second contact portions 212 that comes into contact with the other energy storage device 10, and a plurality of connection portions 213 that connects the first contact portions 211 to the second contact portions 212 (see FIG. 8).

The first contact portion 211 and the second contact portion 212 are plate-shaped regions that extend in the Y-Z plane direction, and are rectangular in shape, elongated in the Y-axis direction when viewed from the X-axis direction. The first contact portion 211 and the second contact portion 212 are arranged alternately in the Z-axis direction such that the lower end of one contact portion 211 (or 212) is at the same position in the Z-axis direction as the upper end of the other contact portion 212 (or 211), and when viewed from the Z-axis direction, the first contact portion 211 and the second contact portion 212 are located offset in the X-axis direction (that is, at a spaced position in the X-axis direction).

The connection portion 213 is a band-shaped region that extends in the X-Y plane (plane that includes the X-axis direction and the Y-axis direction) direction and is elongated in the Y-axis direction, connecting the lower end of the first contact portion 211 to the upper end of the second contact portion 212, or connecting the upper end of the first contact portion 211 to the lower end of the second contact portion 212.

The flow paths R are constructed between the rectangular waveform first body portion 21A having a cross-sectional shape as described above, and two energy storage devices 10 that interpose the first body portion 21A. The flow path R is constructed by an area surrounded by the first contact portion 211, two connection portions 213 extending from the upper and lower ends of the first contact portion 211, and the other energy storage device (energy storage device in contact with the second contact portion 212) 10. The flow path R is constructed by an area surrounded by the second contact portion 212, two connection portions 213 extending from the upper and lower ends of the second contact portion 212, and one energy storage device (energy storage device in contact with the first contact portion 211) 10.

The first regulation portion 22A includes an upper regulation portion 23A and a lower regulation portion 24A. The upper regulation portion 23A comes into contact with the end (lid plate 13) of one side (direction of the terminal 14) in the Z-axis direction of the energy storage device 10 (case 11), adjacent to the first body portion 21A in the X-axis direction. The lower regulation portion 24A comes into contact with the end of the other side (closing portion 121) in the Z-axis direction of the energy storage device 10 (case 11), adjacent to the first body portion 21A in the X-axis direction. The first regulation portion 22A of the present example embodiment includes two upper regulation portions 23A and one lower regulation portion 24A. The first regulation portion 22A regulates relative movement of the energy storage device 10 in the Y-Z plane direction with respect to the first body portion 21A by coming into contact with the energy storage device 10 (case 11 of the energy storage device 10) adjacent to the first body portion 21A from the outside in the Y-Z plane direction. Specifics will be described as follows.

The upper regulation portion 23A is disposed at a corner (corner in the terminal direction) on one side in the Z-axis direction of the first body portion 21A, which is rectangular when viewed from the X-axis direction (direction of the terminal 14). The upper regulation portion 23A is a plate-shaped region extending on both sides in the X-axis direction from the corner of the terminal direction of the first body portion 21A, and is L-shaped and bent along the corner of the terminal direction of the first body portion 21A when viewed from the X-axis direction.

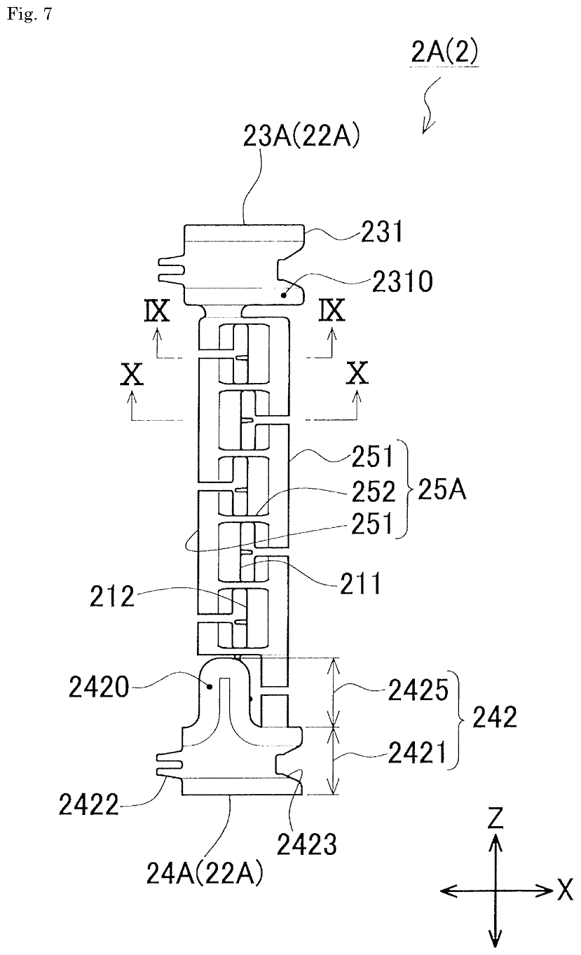

The edge on the other side (lower side in FIG. 7) in the Z-axis direction of the region (upper partial portion 231) extending in the X-Z plane direction of the upper regulation portion 23A and covers the short wall portion 124 of the energy storage device 10 adjacent to the first adjacent structure 2A extends in the X-axis direction. The upper partial portion 231 includes an inclined surface 2310 that extends along the edge on the other side in the Z-axis direction and approaches the energy storage device 10 in the Y-axis direction toward the edge.

The lower regulation portion 24A is a plate-shaped region that extends to both sides in the X-axis direction from the edge of the lower end of the other side in the Z-axis direction of the rectangular first body portion 21A, as viewed from the X-axis direction (direction of the closing portion 121).

The lower regulation portion 24A includes a lower first partial portion 241 that extends from the edge of the other side in the Z-axis direction of the first body portion 21A to both sides in the X-axis direction and extends along the edge on the other side, and the lower second partial portion (partial portion) 242 that extends to both sides in the X-axis direction on the other side in the Z-axis direction at the edge in the Y-axis direction of the first body portion 21A, and extends on one side in the Z-axis direction. The lower regulation portion 24A of the present example embodiment includes one lower second partial portion 242 at each edge of both sides in the Y-axis direction.

The lower first partial portion 241 is a rectangular plate-shaped region in which the X-axis direction is the short side direction and the Y-axis direction is the long side direction.

The lower second partial portion 242 is a plate-shaped region that extends from the edge in the Y-axis direction of the lower first partial portion 241 to one side in the Z-axis direction. The lower second partial portion 242 includes a connecting portion 2421 that connects in the X-axis direction to the lower second partial portion 242 of the adjacent first adjacent structure 2A via the energy storage device 10. The lower second partial portion 242 includes a convex portion 2425 that is convex to one side in the Z-axis direction from a predetermined position in the X-axis direction of the connecting portion 2421 (position deviated from the center in the X-axis direction of the lower second partial portion 242 in the present example embodiment). The lower second partial portion 242 includes an inclined surface 2420 that extends along the edge on one side in the Z-axis direction and approaches the energy storage device 10 in the Y-axis direction toward the edge. The inclined surface 2420 includes both the connecting portion 2421 and the convex portion 2425.

The connecting portion 2421 includes protruding portion 2422 that protrudes from one end in the X-axis direction and a recess portion 2423 that is recessed to accommodate the protruding portion 2422 at the other end in the X-axis direction. As a result, in the two first adjacent structures 2A that are adjacent to each other in the X-axis direction, the protruding portion 2422 of the connecting portion 2421 of one first adjacent structure 2A fits into the recess portion 2423 of the connecting portion 2421 of the other first adjacent structure 2A, or the protruding portion 2422 of the connecting portion 2421 of the other first adjacent structure 2A fits into the recess portion 2423 of the connecting portion 2421 of one first adjacent structure 2A (see FIG. 4).

The convex portion 2425 extends in the Z-axis direction, with the distal end being arc-shaped when viewed from the Y-axis direction. The convex portion 2425 of the present example embodiment is disposed at the edge of the first contact portion 211 in the Y-axis direction in the first body portion 21A. The convex portion 2425 is disposed, when viewed from the Y-axis direction, at a position closer to one side in the X-axis direction than the first contact portion 211 (to the left side in FIG. 7) in the X-axis direction. As shown in FIG. 7, the convex portion 2425 has a shape having line symmetry with respect to a virtual line extending in the Z-axis direction as a symmetrical axis C2.

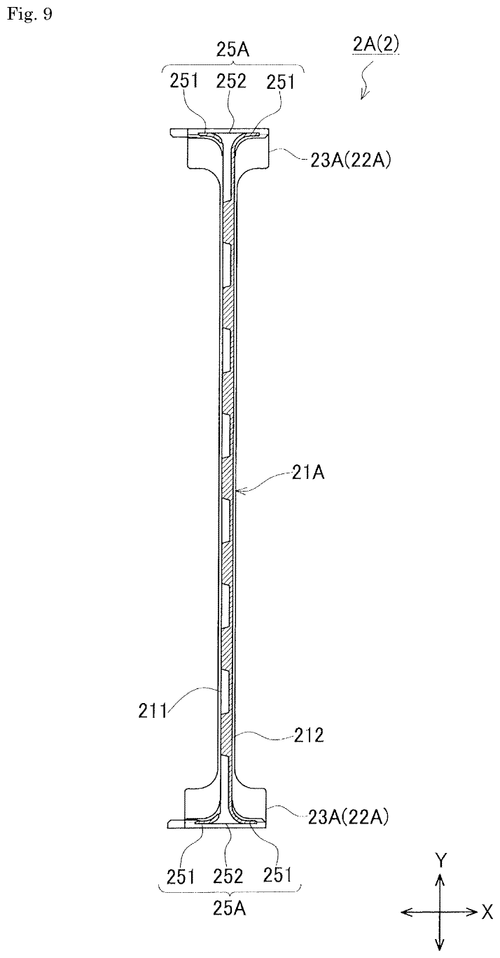

The central cover 25A includes, as shown in FIGS. 9 to 11, a plurality of partial covers 251 extending from the first contact portion 211 or the second contact portion 212 of the first body portion 21A, and a plurality of connection portions 252 connecting the partial covers 251 to each other.

Each of the plurality of partial covers 251 includes a plate-shaped region that extends along the energy storage device 10 with which the first contact portion 211 is in contact and extends in the Z-axis direction from the end of the first contact portion 211 in the Y-axis direction. Each of the plurality of partial covers 251 includes a plate-shaped region that extends along the energy storage device 10 with which the second contact portion 212 is in contact and extends in the Z-axis direction from the end of the second contact portion 212 in the Y-axis direction. The plurality of partial covers 251 has a shape that does not overlap with the flow path R when viewed from the Y-axis direction.

In the plurality of partial covers 251, the partial cover 251 extending from the first contact portion 211 and the partial cover 251 extending from the second contact portion 212 are alternately arranged in the Z-axis direction. In the partial covers 251 that are adjacent to each other in the Z-axis direction, when viewed from the X-axis direction, the end on the other side of the Z-axis direction of one partial cover 251 overlaps with the end on one side of the Z-axis direction of the other partial cover 251. The end on one side of the Z-axis direction of the one partial cover 251 overlaps with the end on the other side of the Z-axis direction of the other partial cover 251.

The plurality of connection portions 252 each connect the ends of the partial covers 251 that are adjacent in the Z-axis direction (that is, ends in the Z-axis direction that overlap when viewed from the X-axis direction).

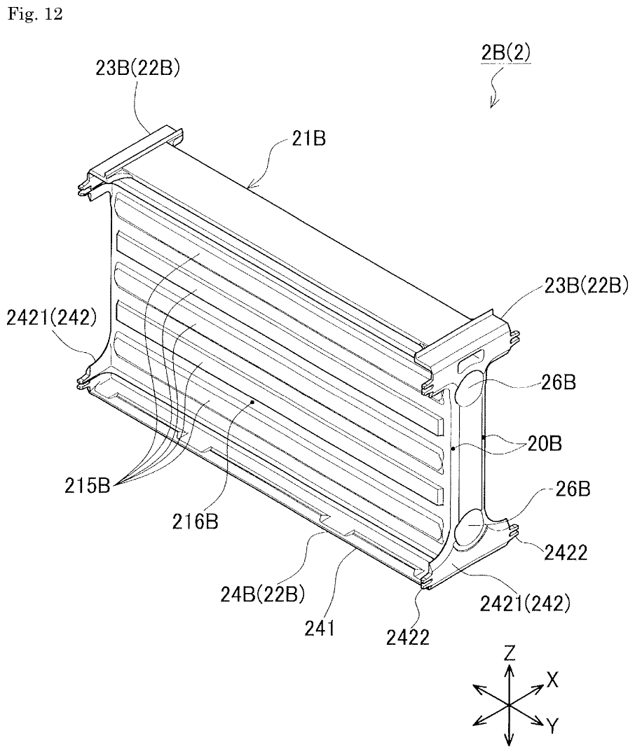

As shown in FIG. 12, each of the second adjacent structures 2B includes a second body portion (adjacent structure body) 21B located between the energy storage devices 10, and a second regulation portion 22B that regulates relative movement of the energy storage device 10 adjacent to the second body portion 21B with respect to the second body portion 21B. The second adjacent structure 2B includes a second fixing portion 26B used to fix the second adjacent structure 2B to the holder 3.

The second body portion 21B is a region extending in the direction of the Y-Z plane and facing the long wall portion 123 of the case 11 of the energy storage device 10 in a state of partial contact. Similarly to the first body portion 21A of the first adjacent structure 2A, the second body portion 21B cooperates with the adjacent energy storage devices 10 to form the flow path R through which a fluid for temperature adjustment can flow between the second body portion 21B and the adjacent energy storage devices 10. The size in the X-axis direction of the second body portion 21B is greater than the size in the X-axis direction of the first body portion 21A (that is, thick-walled). The second body portion 21B of the present example embodiment is a rectangular plate-shaped component with a size that faces the entire surface of the long wall portion 123 of the case 11 of the energy storage device 10 when viewed from the X-axis direction. The second body portion 21B includes a plurality of ribs 215B that extends in the Y-axis direction and is arranged at intervals in the Z-axis direction. The plurality of ribs 215B protrudes from an opposing surface 216B opposite to the energy storage device 10 in the second body portion 21B.

The second regulation portion 22B extends from the corner of the rectangular second body portion 21B when viewed from the X-axis direction to both sides in the X-axis direction, and is in contact with the energy storage device 10 adjacent to the second body portion 21B (in more detail, case 11) from the outside in the Y-Z plane direction, thus regulating relative movement of the energy storage device 10 in the Y-Z plane direction with respect to the second body portion 21B. The second regulation portion 22B of the present example embodiment includes two upper regulation portions 23B and one lower regulation portion 24B, similarly to the first regulation portion 22A.

The lower regulation portion 24B includes, similarly to the lower regulation portion 24A of the first regulation portion 22A, one lower first partial portion 241 and two lower second partial portions 242. Each of the lower second partial portions 242 of the lower regulation portion 24B of the second regulation portion 22B includes only the connecting portion 2421 including protruding portions 2422 protruding outward in the X-axis direction from both ends in the X-axis direction.

The second fixing portion 26B is disposed at the end of the Y-axis direction in the second body portion 21B. The second fixing portion 26B engages with the first fixing portion 4 to fix the holder 3 to the second adjacent structure 2B. The second fixing portion 26B of the present example embodiment is an insert nut. The first fixing portion 4 of the present example embodiment is a bolt. The first fixing portion 4 fastens the holder 3 to the second adjacent structure 2B by engaging (screwing) with the second fixing portion 26B in a state of being inserted into the holder 3.

The second adjacent structure 2B configured as described above includes a band-shaped inclined surface 20B extending across the second body portion 21B and the second regulation portion 22B at the edges on both sides in the X-axis direction on the end surfaces on both sides in the Y-axis direction. The inclined surface 20B is an inclined surface that approaches the energy storage device 10 in the Y-axis direction toward the edge in the X-axis direction.

Each of the two third adjacent structures 2C includes a third body portion 21C located between the energy storage device 10 adjacent in the X-axis direction and the terminal portion 31 of the holder 3, and a third regulation portion 22C that regulates relative movement of the energy storage device 10 adjacent to the third body portion 21C with respect to the third body portion 21C.

The third body portion 21C is a region extending in the Y-Z plane direction and facing the long wall portion 123 of the case 11 of the energy storage device 10 in a state of partial contact. Similarly to the first body portion 21A of the first adjacent structure 2A and the second body portion 21B of the second adjacent structure 2B, the third body portion 21C cooperates with the adjacent energy storage devices 10 to form the flow path R through which a fluid for temperature adjustment can flow between the adjacent energy storage devices 10. The third body portion 21C of the present example embodiment is a rectangular plate-shaped component with a size that faces the entire surface of the long wall portion 123 of the case 11 of the energy storage device 10 when viewed from the X-axis direction. The third body portion 21C includes a plurality of ribs 215C that extends in the Y-axis direction and is arranged at intervals in the Z-axis direction. The plurality of ribs 215C protrudes from an opposing surface 216C opposite to the energy storage device 10 in the third body portion 21C.

The third regulation portion 22C extends from the corner of the rectangular third body portion 21C in the X-axis direction, and is in contact with the energy storage device 10 (in more detail, case 11) adjacent to the third body portion 21C from the outside in the Y-Z plane direction, thus regulating relative movement of the energy storage device 10 in the Y-Z plane direction with respect to the third body portion 21C. The third regulation portion 22C of the present example embodiment extends from the third body portion 21C toward the energy storage device 10 in the X-axis direction.

The third adjacent structure 2C configured as described above includes a band-shaped inclined surface 20C extending across the third body portion 21C and the third regulation portion 22C at the edge facing the energy storage device 10 in the X-axis direction at the end surfaces on both sides in the Y-axis direction (see FIG. 4). The inclined surface 20C is an inclined surface that approaches the energy storage device 10 in the Y-axis direction toward the edge facing the energy storage device 10 in the X-axis direction.

When the plurality of adjacent structures 2 constructed as described above are alternately arranged with the energy storage devices 10 to construct the stacked product D, at least the upper partial portions 231 of the first adjacent structures 2A are connected in the X-axis direction to provide the first cover 240A1 (see FIG. 4). In the stacked product D, at least the lower second partial portions 242 of the first adjacent structures 2A are connected in the X-axis direction to provide the second cover 240A2 (see FIG. 4).

The first cover 240A1 extends in the X-axis direction and covers the end of one side in the Z-axis direction at the end surface in the Y-axis direction of the energy storage devices 10 that construct the stacked product D (direction of the terminal 14). In the first cover 240A1, a band-shaped inclined surface is constructed that extends straight in the X-axis direction along the edge on the other side in the Z-axis direction by the connection of the inclined surfaces 2310 of the plurality of upper partial portions 231 aligned in the X-axis direction.

The second cover 240A2 extends in the X-axis direction and covers the end of the other side in the Z-axis direction at the end surface in the Y-axis direction of the energy storage devices 10 that construct the stacked product D (direction of the closing portion 121 of the case 11). In the second cover 240A2, a band-shaped inclined surface is constructed that extends along the edge on one side in the Z-axis direction (including the edge of the convex portion 2425) by the connection of the inclined surfaces 2420 of the plurality of lower second partial portions 242 aligned in the X-axis direction. The second cover 240A2 includes a plurality of the convex portions 2425 (convex portions 2425 of the lower second partial portion 242) arranged at intervals in the X-axis direction at one end in the Z-axis direction. Each of the convex portions 2425 is arranged at a position where a portion of the convex portion faces, in the Y-axis direction, a space between the energy storage devices 10 that are adjacent in the X-axis direction.

In the stacked product D of the present example embodiment, the band-shaped inclined surface of the first cover 240A1 (inclined surface in which the inclined surfaces 2310 of the upper partial portions 231 are connected) and the band-shaped inclined surface of the second cover 240A2 (inclined surface in which the inclined surfaces 2420 of the lower second partial portions 242 are connected) are connected at both ends in the X-axis direction via the band-shaped inclined surface 20B of the second adjacent structure 2B and the band-shaped inclined surface 20C of the third adjacent structure 2C. As a result, the ring-shaped inclined surface is formed when viewed from the Y-axis direction. The ring-shaped inclined surface is inclined approaching the energy storage device 10 in the Y-axis direction toward the inside of the ring.

As shown in FIGS. 1 to 3, the holder 3 holds the stacked product D by surrounding the periphery of the stacked product D. The holder 3 holds together the plurality of energy storage devices 10 and the plurality of adjacent structures 2 by surrounding the periphery of the plurality of energy storage devices 10 and the plurality of adjacent structures 2. The holder 3 preferably includes a material that has conductivity such as metal. The holder 3 includes the extension 32 that extends from one end to the other end of the X-axis direction of the stacked product D along the end of the stacked product D in the Y-axis direction.

The holder 3 includes the one pair of terminal portions 31 disposed on both sides of the stacked product D in the X-axis direction, the extension 32 disposed on both sides of the stacked product D in the Y-axis direction, and a coupling portion 33 that couples the terminal portions 31 to the extension 32.

Each of the terminal portions 31 is disposed to interpose the third adjacent structure 2C between the terminal portion and the energy storage device 10 disposed at the end in the X-axis direction. The terminal portion 31 includes a terminal portion body 311 extending in the Y-Z plane direction and a collar part 313 that extends from the terminal portion body 311 in a direction away from the energy storage device 10 in the X-axis direction.

The terminal portion body 311 has a rectangular shape with the size corresponding (similar) to the energy storage device 10 when viewed from the X-axis direction. In more detail, the terminal portion body 311 has an elongated, rectangular shape in the Y-axis direction, and includes a plurality of through holes 312 disposed at both ends in the Y-axis direction at intervals in the Z-axis direction. The collar part 313 extends in the X-axis direction from one end of the terminal portion body 311 in the Z-axis direction, and extends in the Y-axis direction.

The extension 32 includes an extension body 320 extending along the end surface of the stacked product D in the Y-axis direction, a first partial portion 325 that extends in the Y-axis direction along the lid plates 13 of the plurality of energy storage devices 10 from one end of the extension body 320 in the Z-axis direction, and extends in the X-axis direction, a second partial portion 326 that extends in the Y-axis direction along the closing portions 121 of the plurality of energy storage devices 10 from the other end of the extension body 320 in the Z-axis direction, and extends in the X-axis direction, and one pair of third partial portions 327 that extend in the Y-axis direction along the terminal portion 31 from both ends of the extension body 320 in the X-axis direction, and extend in the Z-axis direction.

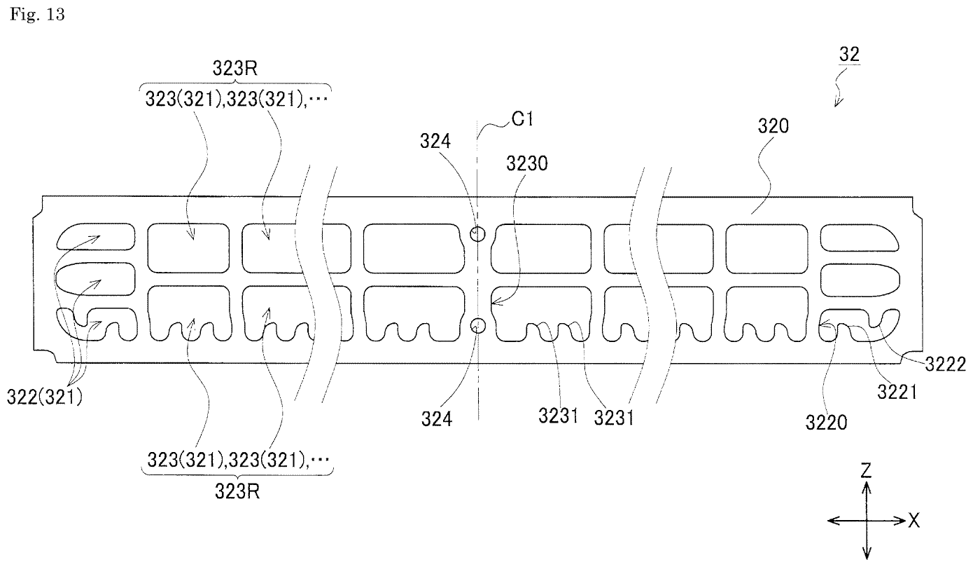

The extension body 320 is a plate-shaped region extending along the short wall portions 124 of the plurality of energy storage devices 10. The extension body 320 includes a plurality of vent holes 321 that penetrates in the Y-axis direction to allow a fluid for temperature adjustment to flow into or out of the flow path R, and a first fixing hole 324 that penetrates in the Y-axis direction at a position opposing the second fixing portion 26B of the second adjacent structure 2B. The extension body 320 of the present example embodiment has, as shown in FIG. 13, a long rectangular shape in the X-axis direction, having a line-symmetrical shape with a centerline (virtual line) C1 that extends in the Z-axis direction at the center position in the X-axis direction as a symmetrical axis. The first fixing portion 4 is inserted into the first fixing hole 324.

The plurality of vent holes 321 includes a plurality of first vent holes 322 arranged at both ends of the extension body 320 in the X-axis direction, and a plurality of second vent holes 323 arranged at positions closer to the center in the X-axis direction than the first vent holes 322 at both ends of the extension body 320.

The plurality of second vent holes 323 is arranged in the X-axis direction to construct a row of the second vent holes 323 (vent hole row) 323R. A plurality of vent hole rows 323R is arranged (two rows in the example of the present example embodiment) in the Z-axis direction.

In the extension body 320, a second vent hole peripheral portion 3230 that defines the second vent hole 323 of the vent hole row 323R located at the most opposite side in the Z-axis direction (the lowest side in FIG. 13) includes at least one convex portion 3231 that protrudes to one side in the Z-axis direction in the region on the other side in the Z-axis direction. The second vent hole peripheral portion 3230 of the present example embodiment includes a plurality of (two in FIG. 13) convex portions 3231.

The plurality of convex portions 3231 is arranged at intervals in the X-axis direction, and each of the convex portions 3231 has an asymmetrical shape in the X-axis direction. The convex portion 3231 is arranged at a position facing a space between the energy storage devices 10 adjacent via the adjacent structure 2 in the Y-axis direction.

In the convex portion 3231, the edge in the direction of the centerline C1 of the extension body 320 in the X-axis direction extends along the Z-axis direction. In the convex portion 3231, the edge on the outside of the extension body 320 in the X-axis direction (in the direction opposite to the centerline C1 in the X-axis direction) extends in an arc shape. The convex portion 3231 has a so-called shark fin shape. The convex portion 3231 is arranged at a position that faces the convex portion 2425 of the second cover 240A2 in the Y-axis direction (position that overlaps or substantially overlaps with the convex portion 2425 when viewed from the Y-axis direction).

The plurality of first vent holes 322 is arranged in the Z-axis direction at each end of the extension body 320 in the X-axis direction. The size of the first vent hole 322 in the Z-axis direction is smaller than the size of the second vent hole 323 in the Z-axis direction.

A first vent hole peripheral portion 3220 that defines the first vent hole 322 located on the most opposite side in the Z-axis direction in the plurality of first vent holes 322 includes a first convex portion 3221 that protrudes to the one side in the Z-axis direction in a region on the other side in the Z-axis direction. The first vent hole 322 located on the most opposite side in the Z-axis direction also includes a second convex portion 3222 that protrudes to the other side in the Z-axis direction in a region on one side in the Z-axis direction. The first convex portion 3221 is located in the direction of the centerline C1 relative to the second convex portion 3222 in the X-axis direction.

The first convex portion 3221 has the same shape (shark fin shape) as the convex portion 3231 of the second vent hole 323 on the most opposite side in the Z-axis direction, protruding in the same direction. The second convex portion 3222 has the same shape as the convex portion 3231 of the second vent hole 323, protruding in the opposite direction from the first vent hole peripheral portion 3220.

The plurality of first fixing holes 324 is arranged at intervals in the Z-axis direction at the central position of the extension body 320 in the X-axis direction. The two first fixing holes 324 are arranged in the extension body 320 of the present example embodiment. The two first fixing holes 324 are arranged at positions that overlap with the two second fixing portions 26B of the second adjacent structure 2B when viewed from the Y-axis direction.

The first partial portion 325 and the second partial portion 326 are elongated band-shaped regions in the X-axis direction. The width (size in the Y-axis direction) of the central part of the second partial portion 326 in the X-axis direction (region excluding both ends) is greater than the width of the first partial portion 325. Each of the pair of third partial portions 327 includes a plurality of second fixing holes 3271 arranged at intervals in the Z-axis direction. The second fixing holes 3271 are arranged at positions that face the through holes 312 of the terminal portion 31.

The coupling portions 33 fix the terminal portion 31 and the extension 32 in a state of being inserted into the through holes 312 of the terminal portion 31 and the second fixing holes 3271 of the extension 32 (in more detail, third partial portion 327). The coupling portions 33 of the present example embodiment include a bolt 331 and a nut 332.

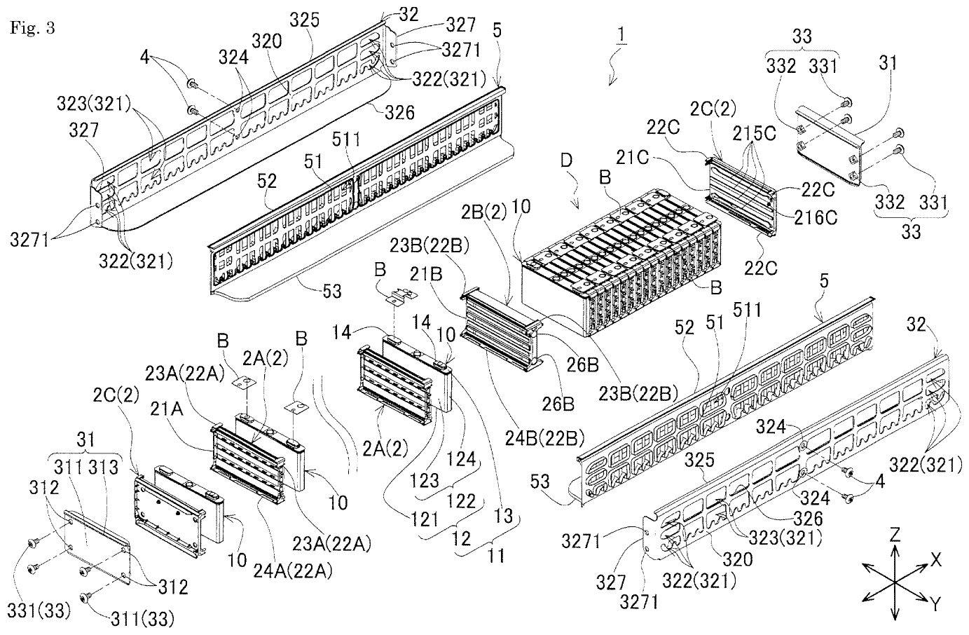

The insulator 5 has insulating properties. The insulator 5 is disposed between the extension 32 and the stacked product D, as shown in FIG. 3. The energy storage apparatus 1 of the present example embodiment includes one pair of insulators 5. The insulator 5 covers the area facing the plurality of energy storage devices 10 in the extension 32. As a result, the insulator 5 insulates between the extension 32 and the plurality of energy storage devices 10.

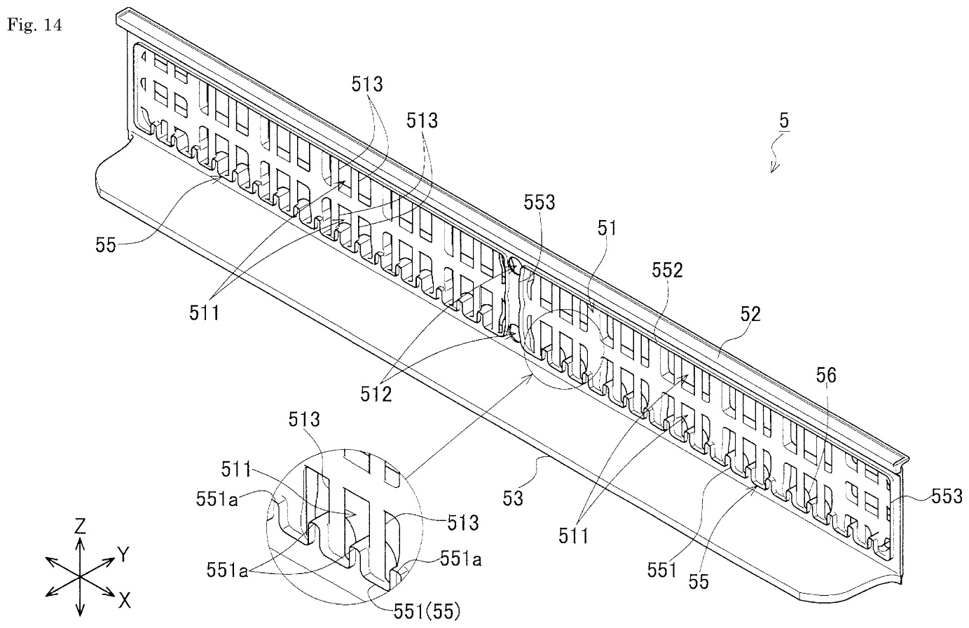

The insulator 5 is disposed between the stacked product D and the extension body 320, as shown in FIGS. 14 to 18. The insulator 5 includes an insulating portion body (insulator body) 51 that includes vent areas 511 penetrating in the Y-axis direction at positions opposing the vent holes 321 of the extension body 320, a first insulating portion 52 disposed between the stacked product D and the first partial portion 325, and a second insulating portion 53 disposed between the stacked product D and the second partial portion 326.

The insulator 5 of the present example embodiment includes a first rib 55 that extends from the insulating portion body 51 in the Y-axis direction and comes into contact with the stacked product D, and extends from the energy storage device 10 at one end to the energy storage device 10 at the other end among the plurality of energy storage devices 10 that are consecutively arranged in the X-axis direction in the stacked product D. The insulator 5 includes a plurality of second ribs 56 that protrudes from the insulating portion body 51 to the opposite side of the stacked product D in the Y-axis direction and extends along the periphery of the vent area 511.

The insulating portion body 51 is a region extending along the opposing surface of the stacked product D in the extension body 320. The insulating portion body 51 of the present example embodiment is a long rectangular region in the X-axis direction that faces the stacked product D and the extension body 320. The insulating portion body 51 includes vent areas 511 arranged at positions facing the vent holes 321 of the extension body 320, and communication holes 512 arranged at positions facing the second fixing portions 26B of the second adjacent structure 2B. The insulating portion body 51 of the present example embodiment includes band-shaped in-hole insulating portions 513 in the vent areas 511. Each of the in-hole insulating portions 513 extends in a band-shaped manner in the Z-axis direction at a position facing the short wall portion 124 of the energy storage device 10 located in the vent area 511 when viewed from the Y-axis direction (at the same position as the short wall portion 124 in the X-axis direction).

The vent area 511 is disposed to overlap with the vent hole 321 of the extension 32. The vent area 511 has the same size and shape as the vent hole 321 of the extension 32 when viewed from the Y-axis direction.

The first insulating portion 52 covers the opposing surface of the stacked product D in the first partial portion 325. The first insulating portion 52 of the present example embodiment extends in the Y-axis direction along the stacked product D from one edge in the Z-axis direction of the insulating portion body 51, and also extends in the X-axis direction.

The second insulating portion 53 covers the opposing surface of the stacked product D in the second partial portion 326. The second insulating portion 53 of the present example embodiment extends in the Y-axis direction along the stacked product D from the other edge in the Z-axis direction of the insulating portion body 51, and also extends in the X-axis direction. In the Y-axis direction, the width of the central part of the second insulating portion 53 in the X-axis direction is greater than the width of the central part of the first insulating portion 52 in the X-axis direction.

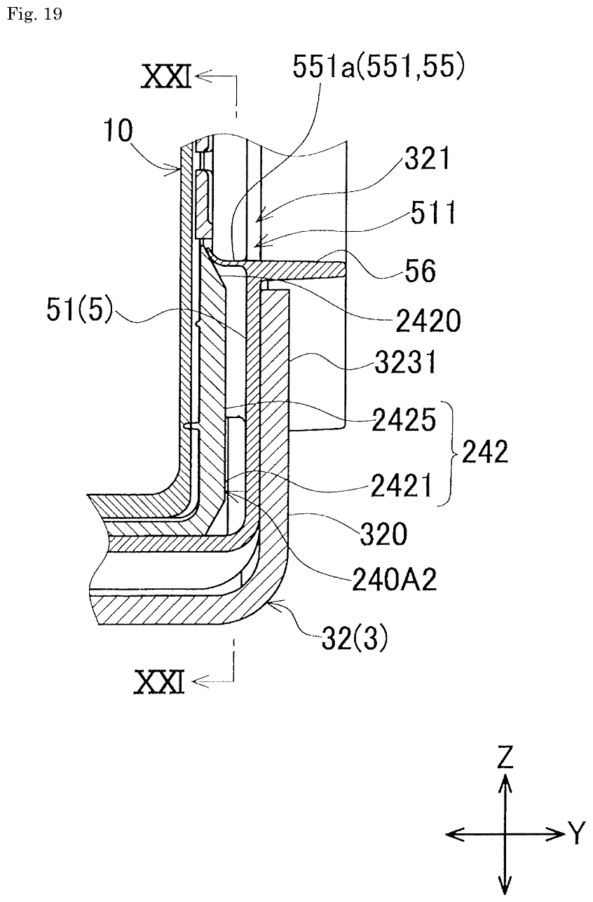

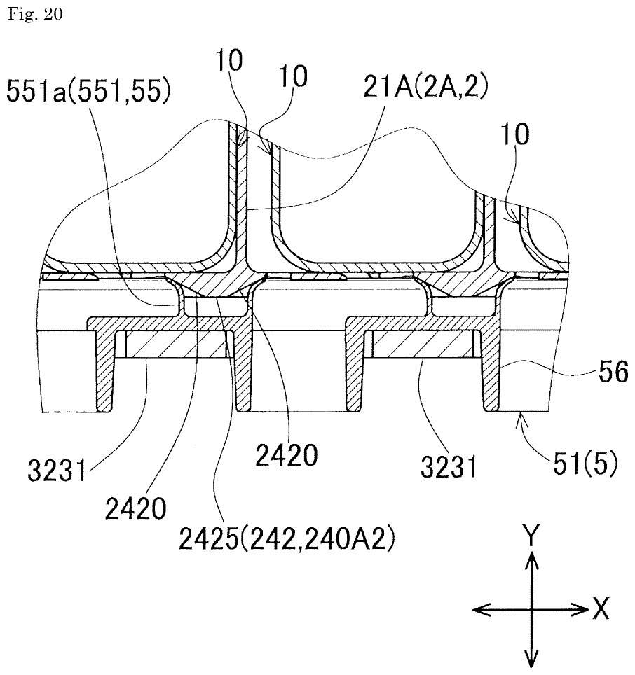

When viewed from the Y-axis direction, the first rib 55 surrounds the plurality of vent areas 511 that are arranged on one side in the X-axis direction from the communication holes 512 (position opposite the second adjacent structure 2B), or the plurality of vent areas 511 that are arranged on the other side in the X-axis direction from the communication holes 512. The insulator 5 includes two first ribs 55 (see FIG. 14). The two first ribs 55 are in contact with the stacked product D at distal ends in the protruding direction (Y-axis direction) over the entire circumferential range. At this time, the distal end of the first rib 55 is bent along an annular inclined surface (annular inclined surface including the inclined surface 2310 of the upper partial portion 231 of the first adjacent structure 2A, the inclined surface 2420 of the lower second partial portion 242, the inclined surface 20B of the second adjacent structure 2B, and the inclined surface 20C of the third adjacent structure 2C) over the entire circumferential range (see FIGS. 19 and 20).

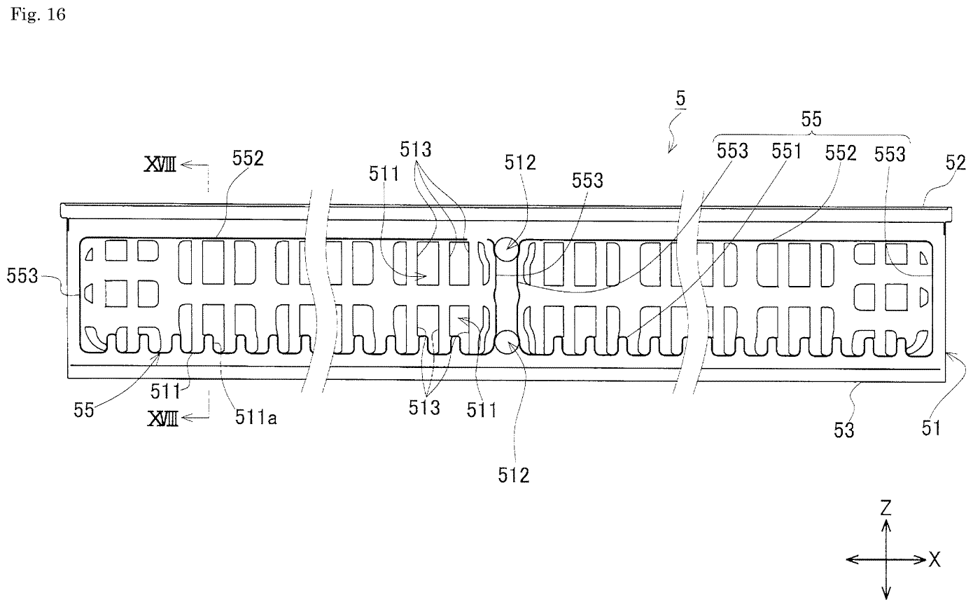

Each of the two first ribs 55 includes a lower region (rib) 551 that extends along the other edge of the insulating portion body 51 in the Z-axis direction, an upper region 552 that extends in the X-axis direction along one edge of the insulating portion body 51 in the Z-axis direction, and a pair of connection regions 553 that extend in the Z-axis direction and connect ends of the lower region 551 and the upper region 552 (ends in the same direction in the X-axis direction). Both ends in the Z-axis direction of the connection region 553 (boundary with the lower region 551 or the upper region 552 in the connection region 553) are arc-shaped. Four corners of the first rib 55 are arc-shaped when viewed from the Y-axis direction. (See FIG. 16)

In the first rib 55 of the present example embodiment, the region that comes into contact with the first cover 240A1 (in more detail, band-shaped inclined surface in which the inclined surfaces 2310 of the upper partial portions 231 are connected) is the upper region 552. The region that comes into contact with the second cover 240A2 (in more detail, band-shaped inclined surface in which the inclined surfaces 2420 of the lower second partial portions 242 are connected) is the lower region 551. In the first rib 55, the region that comes into contact with the inclined surface 20B of the second adjacent structure 2B or the inclined surface 20C of the third adjacent structure 2C is the connection region 553.

The lower region 551 includes at least one inner baffle (baffle) 551a that is convex toward one side in the Z-axis direction. The lower region 551 of the present example embodiment includes a plurality of the inner baffles 551a disposed at intervals in the X-axis direction. The plurality of inner baffles 551a is disposed at positions facing the convex portions 2425 of the second cover 240A2.

In more detail, each of the plurality of inner baffles 551a is a region that comes into contact with the convex portion 2425 of the second cover 240A2 (inclined surface 2420) in the lower region 551, and has a shape corresponding (similar) to the convex portion 2425 (the same shape in the present example embodiment) when viewed from the Y-axis direction. The lower region 551 includes a plurality of the inner baffles 551a arranged at intervals in the X-axis direction. Each of the inner baffles 551a is arranged at a position that faces, in the Y-axis direction, a space between the energy storage devices 10 adjacent in the X-axis direction.

The upper region 552 extends straight in the X-axis direction. The connection region 553 extends straight in the Z-axis direction, except for both ends in the Z-axis direction (regions extending in an arc shape at the boundary with the lower region 551 or the upper region 552).

The second rib 56 extends outward through the vent hole 321 of the extension 32 opposite in the Y-axis direction over the entire circumferential range of the opening periphery of the vent area 511. The second rib 56 extends from the opening periphery of the vent area 511. The insulator 5 includes a plurality of the second ribs 56. The second rib 56 extends in the circumferential direction in a state of being adjacent to (in contact with) the opening periphery inside of the opening periphery of the vent hole 321. The second rib 56 has the same shape as the vent hole 321 when viewed from the Y-axis direction. The second rib 56 includes an outer baffle 56a that protrudes to one side in the Z-axis direction at a position facing the convex portion 3231 in the second vent hole peripheral portion 3230 of the vent hole 321.

The outer baffle 56a, when viewed from the Y-axis direction, has a shark fin shape similar to the shape of the convex portion 3231 in the second vent hole peripheral portion 3230 of the vent hole 321. The shape and size of the outer baffle 56a are different from the inner baffle 551a of the first rib 55 as viewed from the Y-axis direction. By causing the inner baffle 551a to have a shape smaller than and different from the outer baffle 56a, it is possible to secure the area of a flow path (opening area) when a fluid for temperature adjustment passes through the vent hole 321. By disposing the outer baffle 56a having the shark fin shape at a position where the region (side) where the shark fin shape steeply rises faces the flow path R adjacent to the adjacent structure 2 (position partially overlaps in the present example embodiment), the area (opening area) of the flow path for a fluid for temperature adjustment can be secured. In the energy storage apparatus 1 of the present example embodiment, the outer baffle 56a and the inner baffle 551a are positioned with a slight positional offset in the X-axis direction.

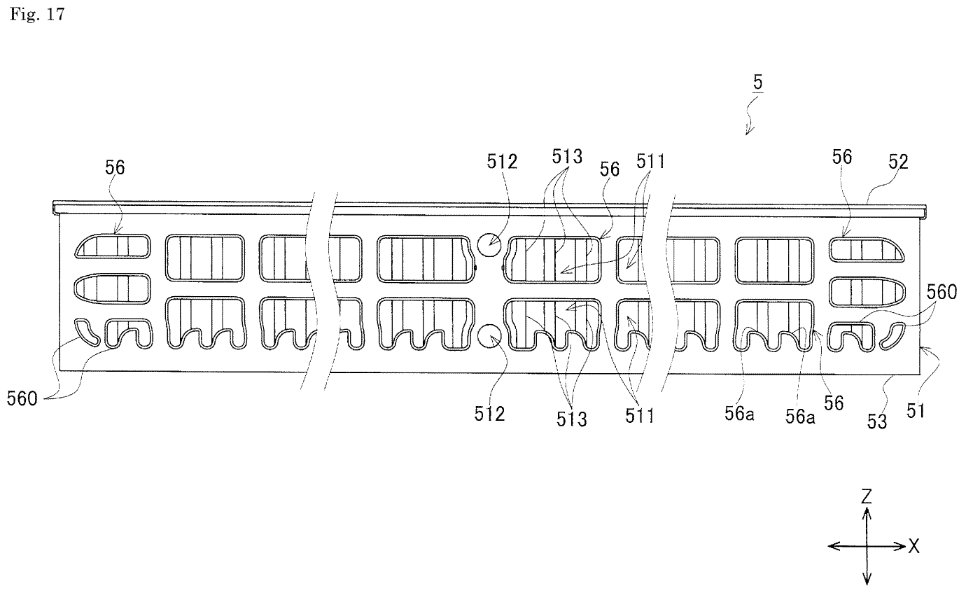

In the insulator 5, the second rib 56 located at a position facing the first vent hole 322 located at the most opposite side in the Z-axis direction of the extension 32 is disposed to be divided into two annular ribs 560 corresponding to one first vent hole 322 (see FIG. 17).

The energy storage apparatus 1 of the present example embodiment configured as described above includes the stacked product D that includes the plurality of energy storage devices 10 arranged in the X-axis direction, the holder 3 to hold the stacked product D, the holder 3 including the extension 32 that extends from one end to the other end of the stacked product D in the X-axis direction along the end of the stacked product D in the Y-axis direction, and the insulator 5 to insulate between the stacked product D and the extension 32. The insulator 5 includes the insulating portion body (insulator body) 51 extending along the opposing surface of the stacked product D in the extension 32, and the lower region (rib) 551 extending in the Y-axis direction from the insulating portion body 51 and to come into contact with the stacked product D, the lower region 551 extending from the energy storage device 10 at one end to the energy storage device 10 at the other end in the X-axis direction among the plurality of energy storage devices 10. The lower region 551 includes the inner baffle (baffle) 551a that is convex on one side in the Z-axis direction. The inner baffle 551a is arranged such that a portion of the inner baffle 551a is located between the adjacent energy storage devices 10 in the X-axis direction. The inner baffle 551a is arranged at a position that faces, in the Y-axis direction, a space between the energy storage devices 10 that are adjacent in the X-axis direction.

When the energy storage apparatus 1 is positioned with one end in the Z-axis direction (direction of the terminal 14 of the energy storage device 10) facing upward, if water such as condensation is present on the surface of the stacked product D (in more detail, on the short wall portion 124 of the energy storage device 10 or the like), the water may flow down along the surface of the end of the stacked product D in the Y-axis direction, and the water W may accumulate at the contact position between the stacked product D and the lower region (rib) 551 in the first rib 55 (see FIG. 21). In this case, with the energy storage apparatus 1 according to the present example embodiment, in the range where the lower region 551 extends in the X-axis direction, the inner baffle 551a can reduce or prevent conduction between the adjacent energy storage devices 10 (case 11 with exposed metal surfaces) due to the water W. Therefore, the occurrence of electrolytic corrosion caused by water is reduced or prevented in the adjacent energy storage devices 10.

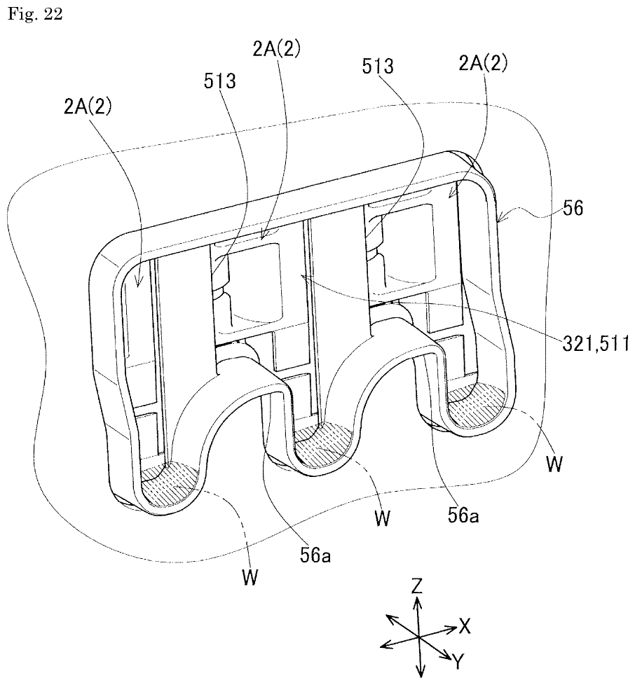

At this time, the accumulated water W may flow out to the outside of the extension 32 in the Y-axis direction (position of the second rib 56) through the vent hole 321 and the vent area 511, as shown in FIG. 22. Even in such a case, the conduction caused by the accumulated water W between the adjacent energy storage devices 10 (case 11 with exposed metal surfaces) at the position of the outer baffle 56a is prevented.

In the energy storage apparatus 1 of the present example embodiment, the stacked product D includes three or more energy storage devices 10 and the first adjacent structures (adjacent structures) 2A, each of which is arranged between the adjacent energy storage devices 10 and has insulating properties. The first adjacent structure 2A includes the lower second partial portion (partial portion) 242 that covers a portion of the end surface (short wall portion 124) of the adjacent energy storage device 10 in the Y-axis direction. The lower second partial portions 242 of the plurality of first adjacent structures 2A are aligned in the X-axis direction to construct the second cover (cover) 240A2. The lower region 551 of the first rib 55 is in contact with the second cover 240A2.

With such a configuration, the energy storage apparatus 1 is positioned with one end of the Z-axis direction facing upward, and both the second cover 240A2 and the lower region 551 have insulating properties. Even if the water W such as condensation accumulates at the contact position between the lower region 551 of the first rib 55 and the second cover 240A2, the conduction caused by the water W between the energy storage devices 10 included in the stacked product D is more effectively reduced or prevented in the range of extension of the lower region 551 in the X-axis direction. This makes it less likely that water-induced electrolytic corrosion will occur in the energy storage apparatus 1.

In the energy storage apparatus 1 of the present example embodiment, the second cover 240A2 extends in the X-axis direction along the edge on one side of the Z-axis direction, and includes the inclined surface (surface in which the inclined surfaces 2420 of the lower second partial portions 242 are connected) approaching the energy storage device 10 in the Y-axis direction toward the edge. In the lower region 551 of the first rib 55, the distal end of the lower region 551 bends to follow the inclined surface (see FIGS. 19 and 20).

With such a configuration, the lower region 551 (first rib 55) bends such that the distal end is aligned with the inclined surface of the second cover 240A2 (surface where the inclined surfaces 2420 of the lower second partial portions 242 are connected), thus pressing the distal end of the lower region 551 against the second cover 240A2. This brings the lower region 551 and the second cover 240A2 into close contact. This more reliably prevents the water W from entering between the lower region 551 (first rib 55) and the second cover 240A2.

In the energy storage apparatus 1 of the present example embodiment, the inner baffle 551a faces a space between the adjacent energy storage devices 10 in the lower region 551 of the first rib 55. At one edge in the Z-axis direction of the second cover 240A2, the convex portions 2425, which are convex on one side in the Z-axis direction and have a shape similar to or the same as the shape of the inner baffle 551a, are arranged at positions facing the inner baffle 551a in the range where the lower regions 551 of the first ribs 55 in the X-axis direction are arranged.

With such a configuration, when the energy storage apparatus 1 is positioned with one end in the Z-axis direction facing upward, the conduction between the adjacent energy storage devices 10 due to the water W at the contact position between the stacked product D and the lower region 551 of the first rib 55 is prevented.

The energy storage apparatuses of the present invention are not limited to the above-described example embodiments, and various changes can of course be made without departing from the gist of the present invention. The configuration of one example embodiment can be added to the configuration of another example embodiment. A portion of the configuration of one example embodiment can be replaced with the configuration of another example embodiment. A portion of the configuration of one example embodiment can be deleted.

In the energy storage apparatuses of the above example embodiments, the lower regions (ribs) 551 of the first ribs 55 are arranged in a range that faces all the energy storage devices 10 included in the stacked product D in the X-axis direction, but the energy storage apparatus is not limited to this configuration. The lower regions 551 may be arranged in a range that faces some energy storage devices 10 among the plurality of energy storage devices 10 included in the stacked product D in the X-axis direction. In more detail, a configuration may be adopted in which the lower regions 551 extend from the energy storage device 10 at one end to the energy storage device 10 at the other end among two or more energy storage devices 10 that are included in the plurality of energy storage devices 10 and are arranged consecutively in the X-axis direction.

With such a configuration, in the range where the lower region (rib) 551 extends in the X-axis direction, the conduction between the adjacent energy storage devices 10 due to the water (for example, water W such as condensed water accumulated at the contact position between the stacked product D and the lower region 551 as shown in FIG. 21) is prevented in the inner baffle 551a. Therefore, the occurrence of electrolytic corrosion caused by water is reduced or prevented in the adjacent energy storage devices 10.

In the energy storage apparatuses of the above example embodiments, the lower region 551 is a portion of the annular first rib 55 when viewed from the Y-axis direction, but the energy storage apparatus is not limited to this configuration. The lower region 551 may be separated from other regions in the first rib 55 (regions excluding the lower region 551) 552 and 553. The lower region 551 may be arranged independently.

In the energy storage apparatuses of the above example embodiments, the lower region (rib) 551 is arranged to be divided into one side region and the other side region by the second adjacent structure 2B of the stacked product D in the X-axis direction, but the energy storage apparatus is not limited to this configuration. The lower region 551 may extend continuously from one end to the other end of the stacked product D in the X-axis direction.

The specific configuration of the inner baffle 551a included in the lower region 551 is not limited. The inner baffle 551a of the above example embodiments has the same shape as the convex portion 2425 of the second cover 240A2 when viewed from the Y-axis direction, but may be different. The inner baffle 551a of the above example embodiments has a line-symmetrical shape with respect to the Z-axis direction as a symmetrical axis when viewed from the Y-axis direction, but may also have an asymmetrical shape. The inner baffle 551a of the above example embodiments has a shape that steeply rises to the one side in the Z-axis direction relative to the other regions of the lower region 551 (regions other than the inner baffle 551a), but may also have a gently rising shape, a stepped shape, or the like. The inner baffle 551a may have the same shape as the outer baffle 56a when viewed from the Y-axis direction.

The lower region 551 of the above example embodiments is in contact (close contact) with the second cover 240A2 in a bent state such that the distal end follows the surface of the second cover 240A2 (see FIGS. 19 and 20), but the lower region 551 is not limited to this configuration. The lower region 551 may have a predetermined thickness, and may have a configuration in which the distal end is in close contact with the surface of the stacked product D such as the second cover 240A2.

In the lower region 551 of the above example embodiments, the inner baffle 551a is arranged at a position corresponding to (facing in the Y-axis direction) all the energy storage devices 10 in the range where the lower region 551 is arranged in the X-axis direction. However, the lower region 551 is not limited to this configuration. In the lower region 551, the inner baffle 551a may be arranged only at some position of the positions that face a space between the plurality of energy storage devices 10 located in the range where the lower region 551 is arranged in the X-axis direction. With this configuration as well, the conduction between the two energy storage devices 10, which face the position where the inner baffle 551a is arranged, can be reduced or prevented.

The insulator 5 of the above example embodiments includes the first rib 55 (lower region 551) and the second rib 56, but the insulator 5 is not limited to this configuration. The insulator 5 may have a configuration that does not include the second rib 56.

The above example embodiments relate to examples where the energy storage devices are used as a charge-discharge enabled nonaqueous electrolyte secondary battery (lithium ion secondary battery), but the type and size (capacity) of the energy storage devices are arbitrary. Example embodiments of the present invention are applicable to various secondary batteries, as well as to primary batteries and energy storage devices of capacitors such as electric double-layer capacitors.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
a stacked product including a plurality of energy storage devices arranged in a first direction;
a holder to hold the stacked product and including an extension extending in the first direction from a first end of the stacked product to a second end of the stacked product along an end of the stacked product in a second direction perpendicular to the first direction; and
an insulator to insulate between the stacked product and the extension; wherein
the insulator includes:
an insulator body extending along an opposing surface of the stacked product in the extension; and
a rib extending from the insulator body in the second direction and to come into contact with the stacked product, the rib extending from the energy storage device at a first end to the energy storage device at a second end in the first direction among the plurality of energy storage devices;
the rib includes a baffle that is convex on one side in a third direction perpendicular to the first direction and the second direction; and
a portion of the baffle is between adjacent ones of the plurality of energy storage devices in the first direction.

2. The energy storage apparatus according to claim 1, wherein
the stacked product includes three or more of the energy storage devices arranged consecutively;
the stacked product includes an adjacent structure between adjacent ones of the plurality of energy storage devices and includes an insulation property;
the adjacent structure includes a partial portion that covers a portion of an end surface of the energy storage device in the second direction;
a plurality of the partial portions of the adjacent structures is connected in the first direction to define a cover; and
the rib is in contact with the cover.

3. The energy storage apparatus according to claim 2, wherein
the cover includes an inclined surface that extends along an edge on one side of the third direction and approaches the energy storage device in the second direction toward the edge; and
the rib bends such that a distal end of the rib follows the inclined surface.

4. The energy storage apparatus according to claim 2, wherein
the baffle is located at a position corresponding to a space between the adjacent energy storage devices in the rib; and
at an edge on one side of the cover in the third direction, in a range where the rib is arranged in the first direction, a convex portion having a shape that is convex on the one side in the third direction and corresponds to the baffle is located at a position corresponding to the baffle.
